(19) United States
(12) Patent Application Publication
(10) Pub. No.: US 2011/0184800 A1
(43) Pub. Date: Jul. 28, 2011

(54) Systems and methods for accountable media planning

(75) Inventor: Michael Kokernak, Boston, MA (US)

(73) Assignee: Backchannelmedia, Inc., Boston, MA (US)

(21) Appl. No.: 13/065,858

(22) Filed: Mar. 30, 2011

Related U.S. Application Data
(63) Continuation of application No. 11/891,938, filed on Aug. 14, 2007.
(60) Provisional application No. 60/837,690, filed on Aug. 14, 2006.

(51) Int. Cl. G06Q 30/00

(52) U.S. Cl. 705/14.41

(57) ABSTRACT

Systems and methods for facilitating web-based media planning are disclosed. Media campaigns are recommended based on querying a data library and using a targeting goal. A measure of success of the campaign is determined from responses to the campaign.

### CROSS-REFERENCE TO RELATED APPLICATION

This application incorporates by reference herein in the entirety, and claims priority to and benefit of, U.S. Provisional Patent Application No. 60/837,690, entitled “SYSTEMS AND METHODS FOR ACCOUNTABLE MEDIA PLANNING” and filed an Aug. 14, 2006.

### FIELD OF THE INVENTION

The systems and methods described herein generally pertain to the field of media advertising. More particularly, these systems and methods pertain to a web-based media-service platform for optimized media planning; addressable advertising, accountable sales, consumer response tracking, and enhanced transactions through automation and self-service.

### BACKGROUND

The traditional approach to purchasing TV advertisement is under close scrutiny due to an unmistakable fragmentation of today's television audience and their viewing habits. In particular, viewing patterns are changing due to non-linear programming through advanced technologies such as video-on-demand and digital video recording. In addition, TV viewers have access to an ever-increasing number of television channels across a variety of media platforms. The combination of expanding channel capacities, changing viewer habits and emerging technologies consequently creates an array of rich and varied media-buying opportunities for today's advertisers. Moreover, the complex nature of today's media campaigns requires advertising to be accountable, that is, return-on-investment (ROI) of advertisements must be closely tracked to eliminate ineffectual spending. Hence, there exists a real demand for technologies that can increase advertisers' ROI and enhance media-buying efficiencies by providing services that capture the dynamic relationship between consumers and commerce.

### SUMMARY

The systems and methods described herein include, among other things, a web-based media-service platform. This platform offers a user of the platform optimized media-planning strategies, accountable sales and response tracking, and automated transaction-related services.

In one aspect, the media-service platform is a software that provides a client with an interface to a media planning recommendation engine configured to automatically recommend a suitable media advertisement campaign to the client. The recommendation engine performs such recommendation by matching a targeting goal with one or more media outlets, where the targeting goal stipulates at least one desired characteristic the client wants to capture in his or her intended advertisement audience. Exemplary targeting goals include a geographical profile, a demographic profile, and a sales profile. The media-service platform is also adapted to collect a consumer response to the media campaign, wherefrom a measure of success of the media campaign is determined.

In general, media outlets are venues through which a media campaign may be broadcasted. An exemplary media outlet comprises a cable system, a broadcast system, a direct broadcast satellite system, a digital content system, a TELCO system, a RBOC system, or a digital content system.

In operation, the recommendation engine selects a suitable media campaign based on searching a data library using the targeting goal. For example, the recommendation engine first identifies one or more households to whom the media campaign should be served. The recommendation engine then determines a campaign schedule based on characteristics of these households. In certain embodiments, the campaign schedule is determined by the recommendation engine using a search algorithm comprising one of a recency theory, a frequency theory, a flight theory, and a reach theory. The recommendation engine is also able to determine one or more media outlets that may satisfy the campaign schedule.

The resulting media campaign targets at least one household via at least one media outlet of the media-service platform. In some instances, the household is not identifiable to the client or the media outlets. The media campaign is directed, instead, to a broadcasting node linked to the household. In other instances, the identity of the household is explicitly revealed to the client or the media outlets based on the targeting goals. The household identifiable and non-identifiable features of the media-service platform permit the client to develop distinctive advertising strategies while protecting consumer privacy.

In general, the response data, collected from those households responded to the media campaign, is stored in the data library. In one embodiment, the response data is stored in an opt-in database of the data library and is correlated to data associated with the media campaign. In particular, an identification number is used by the data library to link the identity of the household to the media campaign data. The media campaign data also includes an identification tag for matching with its corresponding response data. Exemplary media campaign data includes a campaign script, a telemarketing script, a campaign creative, and a campaign budget. Furthermore, response data in the opt-in database reveals an identity of the household when accessed by the client. This access is permitted only if the household is an opt-in member of the media campaign and the client is an owner of the media campaign.

In another embodiment, the response data is stored in a mass-media portion of the data library in which case the response data does not reveal the identity of the household when accessed by the client.

In one embodiment, the client is able to upload data to and download data from the data library for targeted media planning. For example, the client is able to upload a direct mailing list to the data library which reveals at least one household that should be targeted by the media campaign. In another example, the client is able to download a direct mailing list from the data library. This data downloading is permitted only if each household identified in the mailing list is an opt-in member of the media campaign and the client is an owner of the media campaign.

In another embodiment, the client and the media outlet may log into a web portal connected to the data library for tracking the performance of the media campaign.

In one aspect, a media-service platform is provided that includes a media transaction manager integrated with a data library and a recommendation engine for managing a group of user accounts. The platform also provides an interactive portal for allowing each user access to the media transaction manager, the data library and the recommendation engine. The media transaction manager is further adapted to process a transaction initiated based on the client querying the recommendation engine of the platform using a media targeting goal.

In one embodiment, the media transaction manager includes a media order module operative between at least two users of the platform for performing activities such as delivering advertisement rate information, negotiating a media order, requesting a change to the media order, and processing a media buy based on the media order. The media order module may be further configured to reconcile transaction data from the users, the media transaction manager, and in some instances, a third-party verification service, for verifying a media order. The media order module may also track an order status and export transaction data related to the media order to an internal accounting module or an external accounting database for account processing.

In one embodiment, the media transaction manager includes an accounting module for processing user accounts. The accounting module may perform tasks such as process a payment, track a payment status, and generate accounting data for the user accounts.

In another embodiment, the media transaction manager includes a traffic module for assigning at least one show to a media order, generating a delivery request based on the show, establishing a media delivery, registering and assigning a unique Transaction Identifier to each ad playout instance, tracking the media delivery based on the delivery request, and processing an acknowledgement upon receiving the media delivery. The traffic module also monitors the movement of a consumer response within the platform based on the Transaction Identifier tag associated with an advertisement for which the response is generated.

In certain embodiments, the interactive portal includes a user-configurable dashboard for allowing at least one user to track a performance metric associated with a media campaign. The interactive portal also includes a messaging module for allowing one user of the platform to send a message to another user or to an administrator of the platform. The interactive portal further includes a web-service integration module for connecting the platform to an external web-based network accessible from the web portal. The interactive portal also includes a performance query module for allowing at least one user to drill down into media campaign data and consumer response information stored in the data library. The interactive portal additionally includes an access permission module for assigning a plurality of permission levels to the plurality of users accessing the platform.

### BRIEF DESCRIPTION OF THE DRAWINGS

These and other features and advantages will be more fully understood by the following illustrative description with reference to the appended drawings, in which like elements are labeled with like reference designations, and in which the drawings may not be drawn to scale.

FIG. 1 illustrates an embodiment of a media-service platform of the invention.

FIG. 2 illustrates a process for recommending media outlets to a user according to an embodiment of the invention.

FIG. 3 illustrates a data library of the exemplary media-service platform shown in

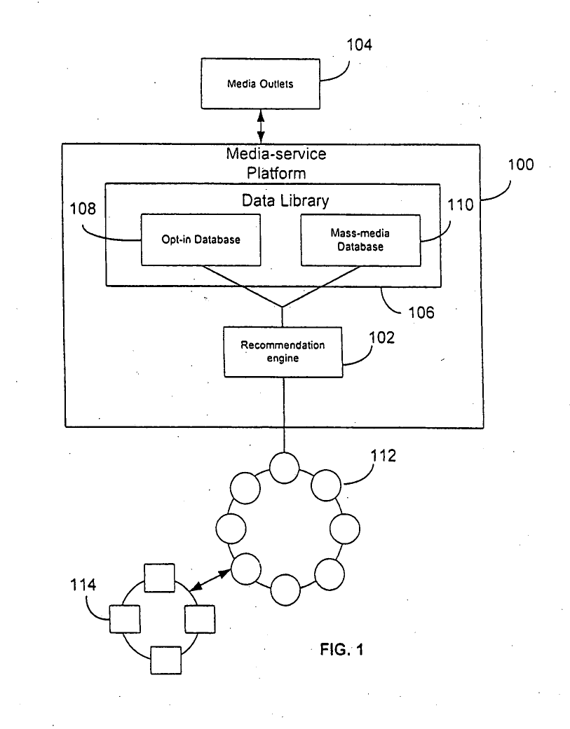

FIG. 1.

FIG. 4 illustrates an embodiment of a media transaction manager of the invention.

FIG. 5 illustrates an embodiment of an interactive web portal of the invention.

FIG. 6 illustrates an exemplary design of a computer architecture used to support the exemplary media-service platform shown in FIG. 1.

### DETAILED SPECIFICATION

The invention, in various embodiments, provides a web-based interactive media-service platform. The following detailed description of the invention refers to the accompanying drawings. The following detailed description does not limit the invention. Instead, the scope of the invention is at least the scope defined by the appended claims and equivalents.

FIG. 1 shows an exemplary configuration of a media-service platform 100 in accordance to one aspect of the present invention. As depicted, the platform 100 includes a campaign media planning recommendation engine 102 which takes as inputs user-defined targeting goals and generates an optimized media campaign schedule along with a list of suitable media outlets. In general, media outlets 104 span the areas of traditional broadcast television, cable television, interactive television, direct-broadcasting satellite systems, TELCO systems, RBOC systems, and digital content systems that include services such as video-on-demand, addressable television, internet, program guides, and mobile devices. Exemplary types of advertisements offered via the media-service platform 100 include linear television commercials, digital on demand commercials, commercials inserted into video on demand, telescoping banner advertisements linking to telescoping contacts, and multi-dimensional advertisements streamed using multiplexing technologies and triggers. Additional advertisement types include banner advertisements linked to external databases, banner advertisements on program guides, interactive television specialized advertisements, and subscription based streaming services such as subscription satellite radio and mobile television advertising. Other advertising types are possible and are not limited by the above exemplary types.

With continued reference to FIG. 1, the media-planning recommendation engine 102 is connected to a data library 106 which has an opt-in database 108 and a mass-media database 110 for storing aggregated data pertaining to household viewing habits as well as media outlet performance. The recommendation engine 102 is able to determine an optimal, preferred, or otherwise suitable or desired media campaign schedule and a list of suitable media outlets by querying the data library 106 using a set of targeting goals input by a client of the platform 100. The recommendation engine 102 accomplishes such a task by first generating a target population using the targeting goals. In one example, the recommendation engine 102 selects the target population based on its receptiveness towards past media campaigns which are similar in certain aspects, as stipulated by the targeting goals, to the current media campaign being planned by the client. In another example, the recommendation engine 102 chooses the target population based on certain common characteristics among the population such as household income, geographic location, types of car driven, etc. Subsequently, the recommendation engine 102 creates an optimized schedule for the current media campaign by analyzing consumer behavior of the target population. The consumer behavior may be from specific historical sales responses, generic consumer characteristics, or a combination of both. In addition, the recommendation engine 102 is adapted to perform analysis of consumer behavior at a depth corresponding to a level of access the client has to the data from which the consumer behavior is determined. A list of suitable media outlets may then be complied accordingly using the projected media campaign schedule. Details of the recommendation engine 102 and the data library 106 will be explained below.

In certain implementations, the target population list includes one or more nodes 112, as illustrated in FIG. 1, where each node 112 links together a neighborhood of households 114 whose identities are concealed from the client. In such case, analysis of audience viewing habits are performed at a node, or neighborhood, level. In some instances, however, the target population list may include one or more households 114 identifiable to the client. Hence, the recommendation engine 102 is adapted to determine an appropriate campaign schedule by analyzing, instead, responses from individual households.

Once a media campaign is underway, the media-service platform 100 collects household responses to the campaign and systematically stores the responses in the data library 106. The media-service platform 100 is thus a self-optimizing system whose refinement is triggered by each new advertisement purchase, consumer response or data upload.

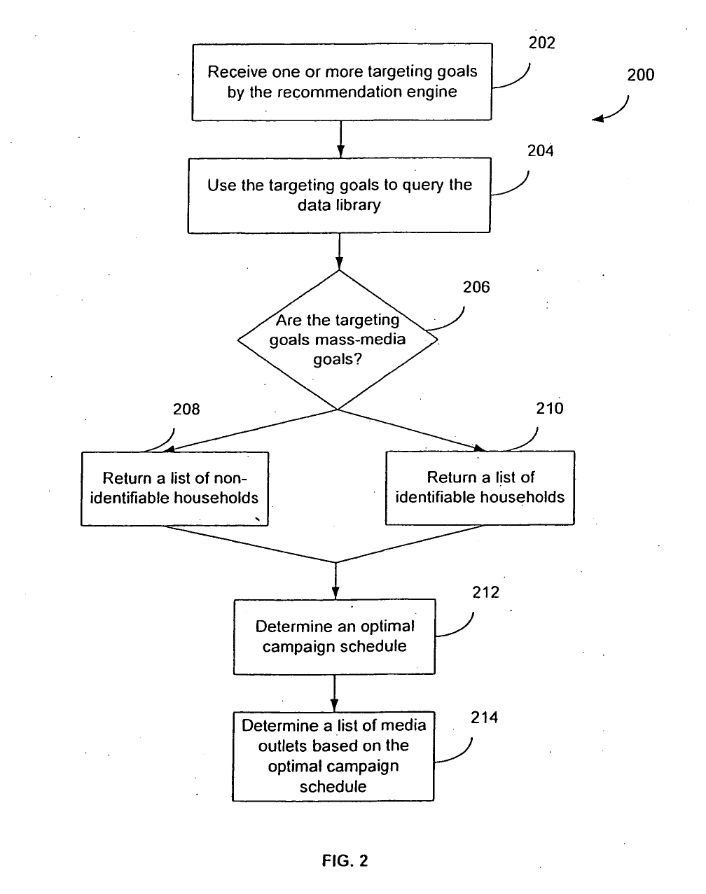

FIG. 2 depicts an illustrative process 200 for creating and refining media campaigns using a media planning recommendation engine, such as recommendation engine 102 of FIG. 1. As shown, process 200 initiates at step 202, according to which a client supplies one or more targeting goals to the recommendation engine 102 that is adapted to generate a target population list, an optimized campaign schedule, and a list of target media outlets based on the targeting goals. These targeting goals specify one or more characteristics the client desires to have in his or her intend audience so as to maximize overall advertisement ROI for the client's media campaign. At step 204, the recommendation engine 102 is adapted to use the input targeting goals to query the data library 106 of the media-service platform 100 for the selection of the intend audience. At step 206, if process 200 determines that the targeting goals are mass-media goals that do not identify any particular households, then the recommendation engine 200 returns, at step 208, a list of non-identifiable households for which the media campaign should be directed. The recommendation engine 102 chooses these non-identifiable households based on criteria such as geographical regions, demographic profiles, and/or historical product responses. In one implementation, these mass-media target goals allow the recommendation engine 102 to create a target population list that includes one or more media nodes 112 each linking together a cluster of households 114, as illustrated in FIG. 1. The individual households 114 belonging to each node, however, are not identifiable to the client.

Alternatively, the recommendation engine 102 determines at step 206 that the targeting goals permit the actual identification of one or more households to whom the media campaign should be served. These identifiable households are, for instance, opt-in members of a current or historical media campaign conducted by the client. The resulting target population generated at step 210 of process 200 is thus a list of identifiable households.

At step 212, the recommendation engine 102 proceeds to use the target population, produced at either step 208 or 210, along with additional client input information such as a desired length of a media campaign, a desired length of an advertisement in a media campaign, and a desired budget range of a media campaign, to determine an optimal weighted-average campaign schedule. The recommendation engine 102 accomplishes this by querying the data library 106 using a set of algorithms each implements one or more media-planning theories. For example, a media-planning theory may be a recency theory according to which product brand choice tends to increase in a household when the household is in the market for a specific product. More particular, the recommendation engine 102 chooses a certain media-planning theory to execute based on the nature of the target population which maybe described in terms of frequency, reach and flight. In general, frequency refers to an average number of times a household has viewed a given advertisement program within a specific time period. Reach refers to the effects of an advertisement on a consumer population after adjusting for the effects of operating systems, distribution outlets, interactive media applications, and digital content distribution engines through which the advertisement is served. Flight refers to a scheduling tactic having alternating periods of advertising and inactivity. Moreover, the recommendation engine 102 is able to generate an optimal campaign schedule using additional third-party research algorithms incorporated into the recommendation engine 102 by the client. Exemplary research algorithms include Myers' Emotional Connection Research, Nielsen Research, Scarborough Research and/or other integrable research strategies.

Subsequently, at step 214, the recommendation engine 102 culls one or more media listings offered by the media outlets 104 in order to select these media outlets that are compatible with the projected media campaign schedule produced from step 212. These media listings may also be stored in the data library 106. It is possible that no media outlets are found during such search. In that case, the client is encouraged to reinitiate the query via the recommendation engine 102 using modified target criteria. According to certain implementations, based on a list of suitable media outlets determined by the recommendation engine at step 214, a client sends the resulting projected media campaign schedule, along with a request for media proposals, to one or more media outlets on the target list. These media outlets may then respond to the client by submitting proposals to the client for review via the media-service platform 100.

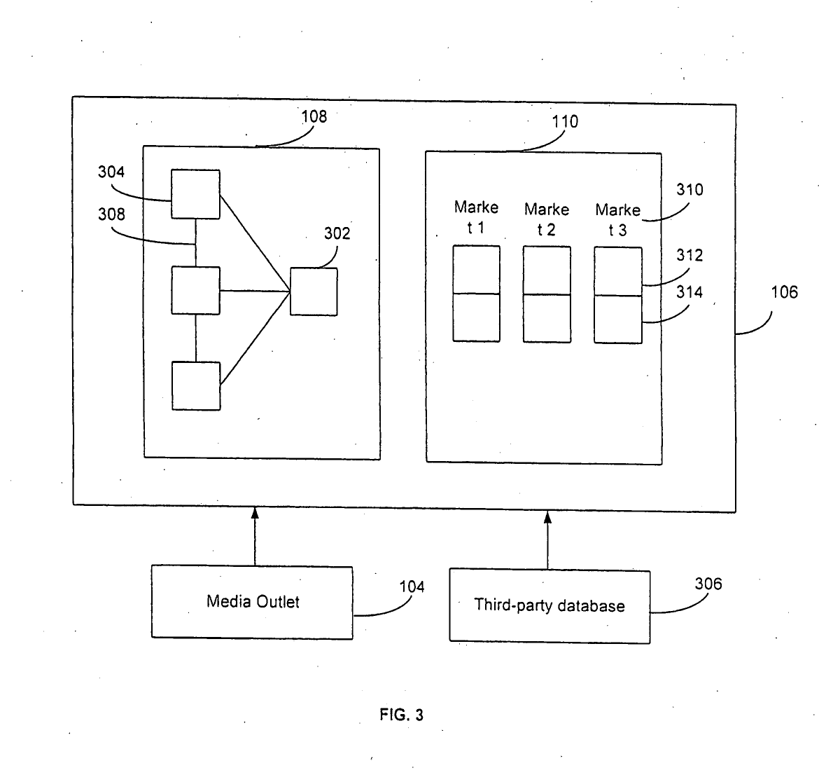

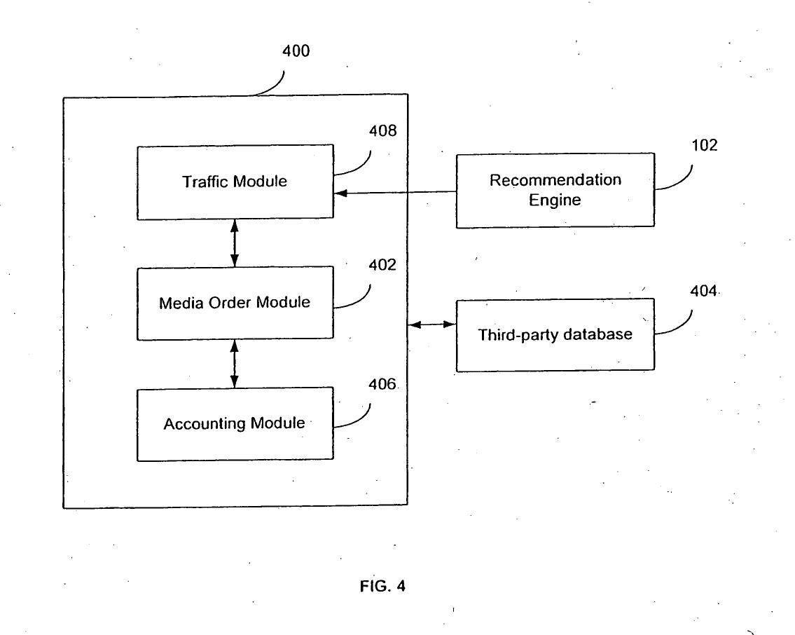

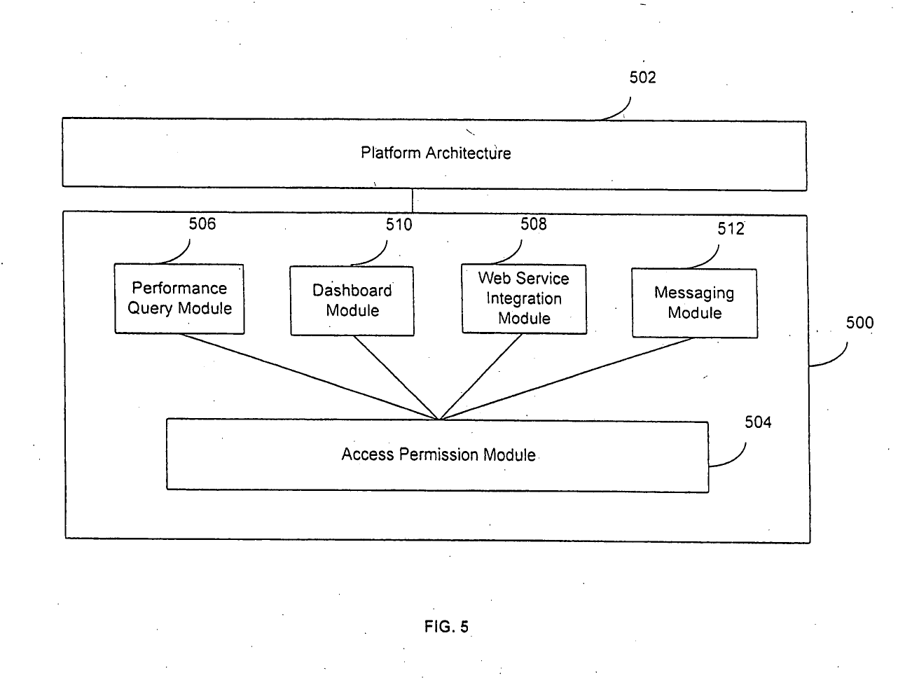

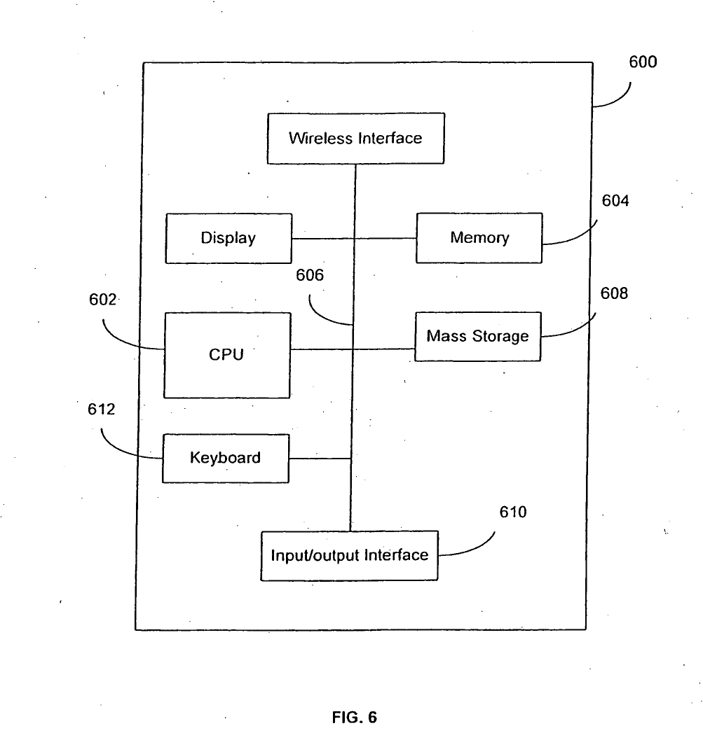

FIG. 3 provides an illustrative embodiment of the data library 106 of FIG. 1 utilized for storing data related to actual household interests and buying habits, which are referred to herein as “response data.” As described above, the data library 106 is partitioned into two distinct databases consisting of an opt-in database 108 and a mass-media database 110. The opt-in database 108 houses and manages response data from identifiable households to whom one or more historical or current media campaigns have been directed. In particular, the response data includes identity-revealing information pertaining to these households. According to one implementation, the response data for each identifiable household is assigned a unique identification number in the opt-in database 108, and the unique identification number is adapted to link the household to a corresponding campaign folder 302. In turn, the campaign folder 302 is configured to store information about a particular media campaign. The campaign folder 302 will be described below in greater detail.

In certain embodiments, the response data collected from a particular household as well as the identification number assigned to the response data are archived in a customer folder 304. Exemplary response data housed in a customer folder 304 includes time of day a product of the media advertisement is purchased, geographical location of the purchase, price of the purchase, any repeat product purchase information, and time from contact to purchase. Through use of a Transaction Identifier or other method of uniquely tagging a media insertion, the response data may also contain media outlet information that specifies the media outlet vehicle and ad playout instance through which the associated media campaign was delivered to the household. The media outlet vehicle may be represented by a set-top box IP address, an internet IP address, a shipping address or a telephone number. The ad playout instance may be represented by a date or a date range, a time or a time range or the execution of a pre-defined, rules-based delivery to a recipient group. Each customer folder 304 is also adapted to include links to one or more third-party databases 306 that provide even more granular household response information, such as full product transaction records or email addresses of the household respondents. An exemplary third-party database 306 is a telemarketing system, a fulfillment database, an interactive television database, a cable database, a satellite radio delivery service, customer ERP, a broadcast database, or a digital media repository residing within, for example, an interne advertisement serving company. A customer folder 304 is further configured to include links 308 to other customer folders 304 targeted by a common media campaign. Hence, a list of respondents may be maintained for each media campaign whose information is stored in a campaign folder 302. It is thus possible for a household to have more than one identification number if the household is associated with multiple media campaigns. Alternatively, a household may have a single identification number and different campaigns are associated through an additional identification number. In operation, when inbound response data from a new respondent of an existing media campaign is archived in the opt-in database 108, the media service platform 100 stores the response data in a new customer folder 304 and assigned to it a unique customer or household number. The folder 304 is then appended to an existing list of customer folders 304 that are already linked to a campaign folder 302. This customer folder 304 may be deleted from the customer list if the respondent decides to opt out of the media campaign at a later time. In certain implementations, the households identified in the opt-in database 108 are opt-in members of their respective media campaigns. More specifically, the opt-in respondents are classified as those who requested a specific action regarding a product via, for example, a phone, a remote control, or an interne link. Explicit opt-in requests may also be made through mailing list submissions or during product purchases. Alternatively, a respondent may select a ‘mass media only’ option when responding to an advertisement so that the respondent cannot be identified for direct media targeting.

In certain implementations, a client or a media outlet 104 is unable to see and drill down into the opt-in database 108 to obtain information regarding a specific household unless the household has given the client or the media outlet 104 an opt-in approval through, for example, a past purchase. In some cases, access to the household identifiable response data is limited to only those clients and media outlets 104 that are owners of the media campaigns. Even though in some instances a household may be associated with multiple media campaigns, a client or a media outlet 104 is only allowed to access the portion of the response data from the household that is pertinent to his or her own campaign. Furthermore, the client is only permitted to download the opt-in list of household respondents of his or her own campaign for refined media planning. Depending on when the download occurs, the size and content of the list may be different, reflective of the dynamic nature of media advertising.

With continued reference to FIG. 3, campaign data pertaining to media campaigns is also organized into individual folders 302 and archived in the opt-in database 108 of the data library 106. Each campaign folder 302 correlates to, for example, a historical or an on-going media campaign managed by the media-service platform 100. In particular, each campaign folder 302 is assigned a unique tag number for indexing to a specific media campaign. This tag number may also be used to link the campaign folder 302 to those customer folders 304 containing household-identifiable responses to the media campaign. Details regarding tag number assignment are described below. Each campaign folder 302 is further adapted to include a campaign script, a telemarketing script, a campaign creative, a package insert, a campaign budget, and a link to a third-party media-service provider 306. A campaign folder 302 may also include rates and/or sales information. In certain examples, access to a campaign folder 304 is limited to those clients or media outlets 104 who are direct owners of the media campaign.

In addition, FIG. 3 provides an exemplary configuration of the mass-media database 110 of the data library 106. The mass-media database 110 contains response data 314 and media campaign information 314 that is accessible to any user of the media-service platform 100. In one implementation, response data 314 in this mass-media database 110 is sufficiently high-level that identities of individual household respondents are concealed from those accessing the database 110. This may be because those respondents have not given their opt-in approval to the media campaigns at the time of data collection; hence their privacies are protected through this non-identifiable approach to information sharing. High-level response data 314 includes information such as a consumer geographical profile or a demographic profile, and may be classified under one or more broad product market categories 310. Likewise, campaign data 312 stored in the mass-media database 110 is sufficiently high-level that product-specific information is removed from the data to provide anonymity to the owners of the media campaigns. Exemplary campaign data includes an advertisement rate profile and a sales profile. Such campaign data may be classified under the same broad product market categories 310 as the response data 314. The sales 312 or response data 314 may be additionally categorized under a “fitness” category that tracks past fitness of specific product consumption patterns without revealing the identities of the associated clients or media outlets. In certain examples, the mass-media portion 110 of the data library 106 is shared with a community of users, and the aggregated information is adapted to assist the users in their advertisement planning. Furthermore, the mass-media database 110 may include weekly or monthly media listing schedules from the media outlets 104 for aiding the users in their media-planning decisions.

As illustrated in FIG. 3, both the opt-in 108 and mass-media 110 databases of the data library 106 are self-optimizing systems whose performance are automatically adjusted based on consumer and campaign information sourced into the media-service platform 100. Such information sourcing may be performed in real-time or on a periodic basis. In one practice, response data is cross-indexed to its respective campaign data in the data library 106. The media-service platform 100 accomplishes this by inserting a unique trackable tag into an advertisement run, which allows the advertisement run to be tracked and correlated to its consumer response element. A tag may comprise a toll-free number, a web URL, a call time, a caller address, a Transaction Identifier embedded in its meta data, or an item order number. The platform 100 also uses the same trackable tag to associate the advertisement run with a campaign folder 302. In one example, a unique tag number, such as a toll-free phone number, is automatically generated and assigned by the platform 100 to a media advertisement run at the moment of its inception. This toll-free number is displayed during the advertisement run so that when a consumer calls the toll-free number in response to the advertised product, the response is registered at the data library 106 and linked to the advertisement data via the toll-free number. In one embodiment, for each stimulus response on the part of a potential customer, the media service platform 100 is adapted to compute a factor that quantifies the confidence level of the matching logics used to index the response data to the advertisement data. The resulting confidence factor may be used to refine subsequent tag number assignments so as to improve the accuracy of response data sourcing. In one embodiment, the algorithms which the confidence factors are determined account for a drag effect or time lag between stimulus display and media response. In addition, a duration of the drag effect is determined based on media outlet types, media categories, and/or product characteristics and may be automatically or manually applied to corresponding response data.

In certain examples, when data is sourced to the mass-media database 110 of the data library 106, identity-revealing portions of the data is removed from the data string before it is correlated with a corresponding product market category 310. In certain examples, data related to media advertisement is sourced into the databases directly from the media outlets 104. In certain examples, third-party research data containing household identification and/or non-identifiable advertisement information is also stored in the databases. In certain examples, response data is captured by the media service platform 100 through web-based integration with third-party vendors such as telemarketing companies, video-on-demand suppliers, set-top box middleware companies, fulfillment houses, payment processing centers, client ERP, broadcast and cable company systems, satellite radio systems, digital telephone systems, and other distributors of digital content. In certain examples, response data is captured by the data library 106 from opt-in households via a remote-control click, a phone call, a website click, a video-on-demand download or other means of communication. These households may easily opt out of a specific media campaign through means such as accessing an opt-out web page, activating a link from the television, making a call to a telemarketing center, or sending a direct-mail notice.

FIG. 4 depicts an exemplary configuration of a media transaction manger 400 of the media-service platform 100 for providing automated media buying and account management services to both clients and media outlets registered with the platform 100. In general, the media transaction manager 400 includes a media order module 402 for transacting media purchases, an accounting module 406 for managing accounts related to media purchases, and a traffic module 408 for assigning and embedding unique advertisement run tags and for tracking media deliveries acquired through media purchases. In particular, the media order module 402 monitors transaction-related activities between authorized media outlets and clients of the platform 100. These activities includes, for example, a media outlet sending a media offer to a client, a client accepting a media offer from a media outlet and initiating a media order, and both a client and a media outlet accepting a media order and initiating a media purchase based on the order. In certain embodiments, the media order module 402 is integrated with the media planning recommendation engine 102 of the media-service platform 100 so that client-approved proposals generated by the recommendation engine 102 triggers at least one new media order. In other examples, a new media order is initiated by a client at the media order module 402 after the client conducts his or her own search of the data library 106 regarding the performance of various media outlets. The media order module 402 further permits clients and media outlets alike to monitor status of their orders as well as reconcile any changes to the orders such as changes to campaign schedules or changes to due dates.

More specifically, the media order module 402 is able to perform reconciliation of data supplied by clients and media outlets for verification of individual media order transactions. The media order module 402 is also able to import additional data into the platform 400 via third-party databases 404 for expanded verification services. In one example, the media order module 402 provides commercial airing verifications by allowing clients access to actual program listing logs so that the clients are able to track show times and contents. Such verification is accomplished by obtaining relevant media delivery traffic data from the traffic module 408, which will be described below. In another example, the media order module 402 is adapted to reconcile sales data with order execution data from appropriate media outlets, along with sales information recorded by the platform 100. In addition, the media order module 402 is able to perform account-related reconciliations by obtaining relevant sales data from the accounting module 406, one or more integrated third-party verification services 404 and cable, broadcast, satellite radio, or other forms of digital media outlets. Details regarding the accounting module 406 will be described below. This reconciliation service is enhanced through integration of the transaction manager 400 with external software such as Electronic Data Interchange/Extensible Markup Language (EDI/XML) software so that data feeds from media outlets and clients are automatically verified. Furthermore, the resulting reconciliation data may be made available to clients and media outlets for review in real-time.

As illustrated in FIG. 4, sales data generated based on media buys is transferred from the media order module 402 to the accounting module 406 of the media transaction manager 400, from which clients and media outlets are able to track their individual account status. The accounting module 406 is also able to automatically generate invoices, bills, credit memos, and statements pertaining to each media purchase, for example. The accounting module 406 is further configured to process credit applications, payments, service cancel requests, service enhancement requests, and customized pricing requests for integrated third-party services. In addition, the accounting module 406 may accept payments from advertising agencies, third party licensees, and clients as well as dispense payments to media outlets using checks, ACH processing, and direct account wiring instructions. Moreover, the accounting module 406 is adapted to make account history information available to clients and media outlets through web log-ins. In addition, fraud control may be provided by the accounting module 404 to ensure user compliance with transaction protocols of the media-service platform 100. The accounting module 406 is also integrable with external accounting software for additional sales data processing. For example, when a client or a media outlet needs to perform a time-sensitive actionable item regarding a media buy, the accounting module 406 sends an auto-alert to the respective parties involved. Failure to perform the actionable item on the part of the involved parties, such as remitting a payment or unable to deliver a campaign order, may result in automatic cancellation of the media buy. In certain instances, data from the accounting module 406 is supplied to the media order module 402 for sales reconciliation processing.

As illustrated in FIG. 4, the transaction manger 400 also includes a traffic module 408 for tracking media delivery traffic among clients, media outlets, and in some instances, external systems. In one example, after a client assigns programs to time slots purchased from a media order, the traffic module 408 is adapted to automatically generate and/or automatically request and obtain from a third-party system a unique tag appendable to each assigned program for accurate consumer response tracking. The traffic module 408 then generates a request, such as a dub request, a digital media delivery request, a satellite transmission request or an internet content delivery request, to track program deliveries to a user-specified media outlet. After receiving such request, the media outlet sends program approvals and traffic instructions to the client along with an acknowledgement of the request, all of which may be processed by the traffic module 408. Furthermore, the traffic module 408 is configured to interface with an external dub house or a third party digital delivery platform 404 for monitoring media content deliveries to the media outlet based on the dub request. The traffic module 408 also maintains a history of programs, tags and dub locations for reconciliation purposes. Data from the traffic module 408 may also be supplied to the media order module 402 for delivery reconciliation.

FIG. 5 provides an illustrative embodiment of a web-based user portal 500 through which users of the media-service platform 100 are able to access the platform 100 for efficient campaign management. Exemplary users of the web portal include advertisers, advertising agencies, media outlets, or supply chain partners such as telemarketing centers, fulfillment companies, or payment processors. In general, the web portal 500 operates as an interface between users and the underlying platform architecture 502, and is specifically designed to enhance a user's interactive experience with the media-service platform 100. As depicted, the web portal 500 includes an access-permission module 504 for authorizing user access to the platform 100, a performance query module 506 for allowing a user to drill down into the system 502, a web-service integration module 508 for providing expanded services, a configurable dashboard module 510 for efficient performance tracking, and a messaging module 512 for facilitated communication among various users of the platform 100.

In one embodiment of the access-permission module 504 of FIG. 5, each authorized user of the platform 100 is assigned a unique user account associated with user contact information. In one instance, if a firm is mounting a large campaign and responsibilities need to be distributed among multiple employees of the firm, the access-permission module 504 is adapted to assign various roles to the employees of the firm so as to delineate their access limits to the platform 100. In addition, the access-permission module 504 is adapted to monitor employee performance by matching their roles with sales and order execution data. In another instance, for an advertising agency with multiple clients, the access-permission module 504 is able to provide similar management capabilities that are customized to the agency's needs. For example, the advertising agency is allowed to manage its accounts according to client types, campaigns, media outlet types, or historical performances. In addition, the agency is able to use the access-permission module 504 to set up various roles and hierarchies for its employee for accessing the platform 100, and their performance may be closely monitored by the platform 100.

In one embodiment, the performance-query module 506 of FIG. 5 is used to present key performance indicator (KPI) graphs, charts and reports to a user in order to assist the user in monitoring his or her campaign progress. These performance metrics are tailored to individual users, and include information such as historical comparisons, historical view of television listings, demographics information of the advertisement market, electronic documents associated with campaigns, and transaction capabilities related to media orders. In addition, through the performance-query module 506, a user is able to drill down into detailed information regarding a media order. Exemplary information includes traffic reports, transaction records, and media outlet historical performance reports. A user is also able to retrieve and download, via the performance-query module 506, electronic documents at each level of the drill-down. In addition, a user is further able to drill down into detailed records queried through third-party web services linked to the media-service platform 100.

In one embodiment, a configurable dashboard module 508 of the web portal 100 is provided to display snapshots of campaign and media sales performance metrics to a user upon the user logging into the platform 100 via, for example, the access-permission module 504. In particular, the dashboard module 508 is able to continuously track and display campaign-related information such as total product sales, media orders for approval, traffic for approval, return rate for products in a campaign, and profit or loss of a campaign. The dashboard module 508 may also feature a preference section for displaying a number of user-selected metrics on the user's desktop. In addition to showing campaign-specific information, the dashboard module 508 may also report global database performance to a user, thereby providing the user with metrics to which the user may compare the performance of his or her own campaign. Such performance metrics include, for example, statistic average complied by the platform 100 based on performance of other campaigns managed by the platform 100. Additional examples of the performance metrics include total media availability in a market category, total media spending in a market category, average sales performance in a market category, and various sales related indices measured across the platform 100 for a given time period.

In another embodiment, the web-service integration module 508 of the web portal 500 is used to connect multiple external systems to the platform 100 through web-based integration. In particular, using the web-service integration module 508, users of the media-service platform 100 are able to initiate queries into other systems. In addition, the web-service integration module 508 assigns a unique identification string to each executed query to reduce traffic errors. Exemplary infrastructures that are established by the web-service integration module 508 to support web integration include a master login feature which allows a user to log into an external database, a status log which records any disruptions of integrated web services, a mapping feature which allows a user to map fields within the media-service platform 100 to fields in a third-party application, and a toolkit which allows an external system to map to the media-service platform 100. Consequently, the web-service integration module 508 is adapted to offer an array of additional services to a user. These services allow a user to perform tasks such as querying inventory levels at a fulfillment house, querying an open inventory at a media outlet, locating dubs or creative at a media outlet, forwarding sales records from a telemarketing system to a fulfillment house, changing inbound telemarketing scripts, and checking a shipment status.

In a further embodiment, a user is able to send messages to administrators or other users of the platform 100 via the messaging module 512 of the web portal 500. These messages may be used for verification purposes, such as verifying traffic contacts, sales contacts and media outlet affiliations. The messaging module 512 is also configured to provide campaign updates to the users. Such messages provide information regarding campaign performance, open media transactions, open traffic instructions, as well as links to other sections of the web portal 500. Furthermore, messages may be sent back and forth between a user and a third-party service provider via the messaging module 512 for providing enhanced communication and customer care. For example, media outlets and third-party systems may post specials, discount offers, and relevant system outages or maintenance information to the entire network of users or a selected group of users.

Additional features of the web-portal allow users to perform negotiations and/or arbitrages based on campaign results generated by the platform. A user may set up an arbitrage via the web portal 500 by specifying automated buying instructions if one or more campaign goals are reached. An arbitrage may also be automatically established by the platform 500 base on pertinent response data stored in the data library 106 such as purchase content, time of day or frequency of purchase, and geographic region of purchase. In certain implementations, a user may set up an automated negotiation scheme over the web portal 500 by specifying a campaign goal, a desired length and availability of the campaign goal and any desired performance adjustments to the campaign goal such as compensation overrides for high-performance campaigns or discounts for low-performance campaigns. In some implementations, the web portal 500 provides a rate of fragmentation to each user, where the rate of fragmentation accounts for all programs, channel capacities, and distribution outlets that have been processed by the media-service platform 500 in a user-specifiable time period. The platform 100 may then compare past media advertising efficiency of a certain category of media campaigns with the computed rate of fragmentation in order to create a targeting algorithm that is able to forecast the effectiveness of future commercial placements. In some implementations, the users are able to establish, via the web portal 500, fixed pricing, goal pricing, response or sales pricing, viewership pricing and run-of-schedule pricing. The web portal also accepts pricing schemes established by third parties involved in a media schedule transaction. In some implementations, users are able to replicate past campaign performance and analyze various pricing scenarios against the rate of fragmentation to recalculate potential pricing values for future campaign planning.

FIG. 6 shows a functional block diagram of a general purpose computer system 600 for performing various functions of the media-service platform 100 according to an illustrative embodiment of the invention. The exemplary computer system 600 includes a central processing unit (CPU) 602, a memory 604, and an interconnect bus 606. The CPU 602 may include a single microprocessor or a plurality of microprocessors for configuring the computer system 600 as a multi-processor system. The memory 604 illustratively includes a main memory and a read-only memory. The computer 600 also includes a mass storage device 608 having, for example, various disk drives, tape drives, etc. The main memory 604 also includes a dynamic random access memory (DRAM) and a high-speed cache memory. In operation, the main memory 604 stores at least a portion of instructions and data for execution by the CPU 602.

The mass storage 608 may include one or more magnetic disk or tape drives or optical disk drives, for storing data and instructions for use by the CPU 602. At least one component of the mass storage system 608, preferably in the form of a disk drive or tape drive, stores the databases used for processing the functions of the media-service platform 100 of the invention. The mass storage system 608 may also include one or more drives for various portable media, such as a floppy disk, a compact disc read only memory (CD-ROM), or an integrated circuit non-volatile memory adapter (i.e. PC-MCIA adapter) to input and output data and code to and from the computer system 600.

The computer system 600 may also include one or more input/output interfaces 610 for communications via a network of the computer system 600. The input/output interface 610 may be a modem, an Ethernet card or any other suitable data communications device. The input/output interface 610 may provide a relatively high-speed link to the network, such as an intranet, internet, or the Internet, either directly or through an another external interface. The communication link to the network may be, for example, optical, wired, or wireless (e.g., via satellite or cellular network). Alternatively, the computer system 600 may include a mainframe or other type of host computer system capable of Web-based communications via the network. In one such embodiment, for example, computer system 600 provides the various functions of the media-service platform 100 using the Software as a Service (“SaaS”) delivery model.

The computer system 600 also includes suitable input/output ports or use the interconnect bus 606 for interconnection with a local display and keyboard 612 or the like serving as a local user interface for programming and/or data retrieval purposes. Alternatively, server operations personnel may interact with the system for controlling and/or programming the system from remote terminal devices via the network.

The computer system 600 may run a variety of application programs and stores associated data in a database of mass storage system 608. One or more such applications may enable the receipt and delivery of messages to enable operation as a server, for implementing server functions relating to the media-service platform 100 of the present invention. The components contained in the computer system 600 are those typically found in general purpose computer systems used as servers, workstations, personal computers, network terminals, and the like. In fact, these components are intended to represent a broad category of such computer components that are well known in the art. Certain aspects of the invention may relate to the software elements, such as the executable code and database for the server functions of the media-service platform 100.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, having a computer readable program code stored thereon.

The following examples provide illustrate usage of the media-service platform 100. In one example, a client of the media-service platform 100 queries the data library 106 of the platform 100 to obtain historical performance information in specific product categories that are of interest to the client. The client then inputs the query results into the recommendation engine 102 of the platform 100 to develop mass-media targets for future media planning. The client is also able to supply the mass-media targets to the recommendation engine 102 to determine those media outlets that are compatible with the targeting goals. In addition, the client may query the media listings, demographic information, projected sales and/or response volume stored in the data library 106 in order to determine additional media outlets. The client may also determine additional media outlets from externally published researches linked to the media-service platform 100.

In another example, a client obtains a list of compatible media outlets as a result of querying the data library 106 using either his own search strategies or search algorithms offered by the recommendation engine 102. the client then sends a request to each media outlet to solicit media proposals for review. In the case that a media proposal from a particular media outlet is deemed acceptable to the client, the client places a media order through the media order module 402 of the transaction manager 400 for initiating a media order transaction between the client and the media outlet. However, the client may request rate reductions or even cancel the order all together if the client uncovers any unsatisfactory media outlet performance information from the data library 106 during the course of the transaction.

In another example, upon the completion of a media campaign, a client is able to develop future media campaigns based on mass media response data collected from the first campaign. More specifically, the client may refine targeting goals for subsequent campaigns by analyzing high-response related information uncovered during the first campaign. For instance, upon the completion of a first campaign, if the media-service platform 100 determines that the highest purchaser of the advertised product were males, between the age of 25 to 34, with income of $75000 or above, living in a warm climate and employed in a high-tech field, the recommendation engine 102 then proceeds to determine those areas in the United States that have the highest concentration of this type of respondents. Campaign managers are thus able to develop a refined or entirely new campaign strategy based on the resulting geographical information. The profiles of the respondents may also be used to uncover like attributes among a list of opt-in households who have yet to respond to the campaign or have not been targeted by the campaign. The campaign manager may download a mailing list of these like households from the data library 106 and send direct mailing postcards or advertisements to the identified households.

In another example, once a media campaign is underway, a campaign manager is able to monitor campaign performance by comparing the performance to statistical averages of campaigns aggregated by the platform. Hence the campaign manager may change the direction of his or her advertisement if the advertisement is performing below the statistical average.

In another example, a user of the media-service platform 100 is prevented from seeing or drilling down into the opt-in portion 108 of the data library 1076 to obtain purchase history associated with selected households unless the user has received opt-in approval from the households. In such a case, the user is only able to see his or her own opt-in list of households. Alternatively, if a user does have access to household-identifiable purchase information, the user is not able to access any other purchase records that do not belong to the user except for pertinent mass-media data stored in the mass-media database 100 of the data library 106. In other words, only direct owners of opt-in household information is able to access that information and use it to target individual households accordingly.

The foregoing description of the preferred embodiment of the invention has been presented for the purposes of illustration and description. It is not intended to be exhaustive or to limit the invention to the precise form disclosed. Many modifications and variations are possible in light of the teaching herein.

1. A method for facilitating web-based media planning, comprising:
receiving a targeting goal input by a user;
recommending a media campaign to the user based on querying a data library using the targeting goal; and
collecting a response to the media campaign, wherefrom a measure of success of the media campaign is determined.

2-30. (canceled)
